(19) United States
(12) Patent Application Publication
(10) Pub. No.: US 2021/0279825 A1
(43) Pub. Date: Sep. 9, 2021

(54) SYSTEM AND METHOD FOR REVENUE AND ASSET MANAGEMENT BASED ON MICRO-SERVICE ARCHITECTURE

(71) Applicant: Transerve Technologies Private Limited, Panaj (IN)

(72) Inventors: Ashwani Kumar Rawat, Panaj (IN); Amarsh Chaturvedi, Panaj (IN)

(73) Assignee: Transerve Technologies Private Limited

(21) Appl. No.: 17/160,987

(22) Filed: Jan. 28, 2021

(30) Foreign Application Priority Data
Mar. 9, 2020 (IN) 202021010101

(51) Int. Cl. G06Q 50/16; G06Q 10/06; G06K 9/00

(52) U.S. Cl. CPC G06Q 50/163; G06K 9/00664; G06Q 10/06312; G06Q 10/0633

(57) ABSTRACT

A system for revenue and asset management based on micro-service architecture is disclosed. The system includes a plurality of containerized micro-service units, configured to manage spatial data information and a plurality of workflows in conjunction with a spatial data managing unit. The system also includes the spatial data managing unit, configured to integrate the plurality of workflows. The spatial data managing unit includes a form designer module, a data collection module, a data analysing module, a verification module and an administrative processing module. The system includes a dashboard unit, configured to display at least one of the collected one or more entries after analysis, the one or more verified entries, and ongoing administrative management of different domains of the revenue and asset management with respect to the property being assessed over a geographical information system map.

This application claims priority from a provisional patent application filed in India having Patent Application No. 202021010101, filed on Mar. 9, 2020, and titled “SYSTEM AND METHOD FOR REVENUE AND ASSET MANAGEMENT”.

### FIELD OF INVENTION

Embodiments of a present disclosure relates to geospatial system based on microservices architecture, and more particularly to a system and a method for revenue and asset management based on micro-service architecture.

### BACKGROUND

Municipal corporations, city councils and other civic bodies are responsible for effectively managing the urban infrastructure, provide citizen services and administrate revenue from the cities. Property tax assessment and collection, water supply asset management, sanitation, solid waste and urban healthcare and education are some of the key tasks that the cities need to perform. Managing city operations involves a set of processes which are heavily dependent on collecting data from the field and processing the data to gain meaningful insights to improve citizen service delivery. Huge amount of data, which was in hard copy format earlier, is now getting digital. Cities have adopted digital platforms for a host of revenue and asset management requirements.

However, the effective use of spatial intelligence has been quite minimal. A large part of the produced information may be located in time and place. Such kind of information is called geospatial data. Before the acquired geospatial data is used in any application, the data has to be first processed. The processing should happen in a reasonable amount of time, so that applications may make use of the most up-to-date information. However, there are inherent challenges related to geospatial data processing.

Conventional proprietary and commercial-off-the-shelf geographic information system (GIS) need to be customized heavily to be able to be effectively used for the desired applications. The geospatial system is now facing a new paradigm shift from desktop-based GIS to the cloud. Therefore, users increasingly face limitations with current solutions and the volume of geospatial data as well as the complexity of the processing algorithms exceed the storage and compute capabilities of their workstations and conventional GIS offers a range of functionality that is not yet available in the cloud server. Such systems involve thousands of lines of code embedded in a single instance. Further, load balancing and resource optimization remain a challenge with such systems.

Hence, there is a need for an improved system for revenue and asset management based on micro-service architecture and a method to operate the same and therefore address the aforementioned issues.

### BRIEF DESCRIPTION

In accordance with one embodiment of the disclosure, a system for revenue and asset management based on micro-service architecture is disclosed. The system includes one or more processors. The system includes a plurality of containerized micro-service units operable by one or more processors. The plurality of containerized micro-service units is configured to manage spatial data information and a plurality of workflows in conjunction with a spatial data managing unit.

The system also includes the spatial data managing unit operable by the one or more processors. The spatial data managing unit is operatively coupled to each of the plurality of containerized micro-service units. The spatial data managing unit is configured to integrate the plurality of workflows in one of a form generation, data collection, data analysing, data verification and data processing. The spatial data managing unit includes a form designer module. The form designer module is configured to design templates of a plurality of forms comprising one or more entry points for capturing data associated with revenue and asset management. The form designer module is also configured to customize the plurality of forms by enabling option to at least one of addition one or more entry points, deletion of one or more entry points, and duplication of one or more entry points or combination thereof.

The spatial data managing unit also includes a data collection module. The data collection module is configured to collect the one or more entries from the plurality of forms via a plurality of feature detection techniques. The spatial data managing unit also includes a data analysing module. The data analysing module is configured to analysis each of collected one or more entries via an analysing technique. The spatial data managing unit also includes a verification module. The verification module is configured to receive verification from a second set of users about each of the collected one or more entries to generate one or more verified entries. The spatial data managing unit also includes an administrative processing module. The administrative processing module is configured to enable administrative management of different domains of the revenue and asset management corresponding to each of the one or more verified entries.

The system also includes a dashboard unit operable by the one or more processors. The dashboard unit is operatively coupled to special data managing unit. The dashboard unit is configured to display at least one of the collected one or more entries after analysis, the one or more verified entries, and ongoing administrative management of different domains of the revenue and asset management with respect to the property being assessed over a geographical information system map.

In accordance with one embodiment of the disclosure, a method for managing revenue and asset by a micro-service architecture is disclosed. The method includes designing templates of a plurality of forms comprising one or more entry points for capturing data associated with revenue and asset management. The method also includes customizing the plurality of forms by enabling option to at least one of addition the one or more entry points, deletion of the one or more entry points, and duplication of the one or more entry points or combination thereof. The method also includes collecting the one or more entries from the plurality of forms via a plurality of feature detection techniques.

The method also includes analysing, each of collected one or more entries via an analysing technique. The method also includes receiving verification from a second set of users about each of the collected one or more entries to generate one or more verified entries. The method also includes enabling administrative management of different domains of the revenue and asset management corresponding to each of the one or more verified entries. The method also includes displaying at least one of the collected one or more entries after analysis, the one or more verified entries, and ongoing administrative management of different domains of the revenue and asset management with respect to the property being assessed over a geographical information system map.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for revenue and asset management based on micro-service architecture in accordance with an embodiment of the present disclosure;

FIG. 2 is a schematic representation of an embodiment representing the micro-service architecture used for managing revenue and asset in accordance of an embodiment of the present disclosure;

FIG. 3 is a schematic representation of an embodiment representing process of management of spatial data information as stated in FIG. 1 in accordance of an embodiment of the present disclosure;

FIG. 4 is a schematic representation of an embodiment representing the plurality of workflows used for managing revenue and asset of FIG. 1 in accordance of an embodiment of the present disclosure;

FIG. 5 is a schematic representation of an embodiment representing the total workflow of revenue and asset management of FIG. 1 in accordance of an embodiment of the present disclosure;

FIG. 6 is a block diagram of a computer or a server in accordance with an embodiment of the present disclosure; and

FIG. 7 is a flowchart representing the steps of a method for managing revenue and asset by a micro-service architecture in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, subsystems, elements, structures, components, additional devices, additional subsystems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system for revenue and asset management based on micro-service architecture. The system includes one or more processors. The system includes a plurality of containerized micro-service units operable by one or more processors. The plurality of containerized micro-service units is configured to manage spatial data information and a plurality of workflows in conjunction with a spatial data managing unit.

The system also includes the spatial data managing unit operable by the one or more processors. The spatial data managing unit is operatively coupled to each of the plurality of containerized micro-service units. The spatial data managing unit is configured to integrate the plurality of workflows in one of a form generation, data collection, data analysing, data verification and data processing. The spatial data managing unit includes a form designer module. The form designer module is configured to design templates of a plurality of forms comprising one or more entry points for capturing data associated with revenue and asset management. The form designer module is also configured to customize the plurality of forms by enabling option to at least one of addition one or more entry points, deletion of one or more entry points, and duplication of one or more entry points or combination thereof.

The spatial data managing unit also includes a data collection module. The data collection module is configured to collect the one or more entries from the plurality of forms via a plurality of feature detection techniques. The spatial data managing unit also includes a data analysing module. The data analysing module is configured to analysis each of collected one or more entries via an analysing technique. The spatial data managing unit also includes a verification module. The verification module is configured to receive verification from a second set of users about each of the collected one or more entries to generate one or more verified entries. The spatial data managing unit also includes an administrative processing module. The administrative processing module is configured to enable administrative management of different domains of the revenue and asset management corresponding to each of the one or more verified entries.

The system also includes a dashboard unit operable by the one or more processors. The dashboard unit is operatively coupled to special data managing unit. The dashboard unit is configured to display at least one of the collected one or more entries after analysis, the one or more verified entries, and ongoing administrative management of different domains of the revenue and asset management with respect to the property being assessed over a geographical information system map.

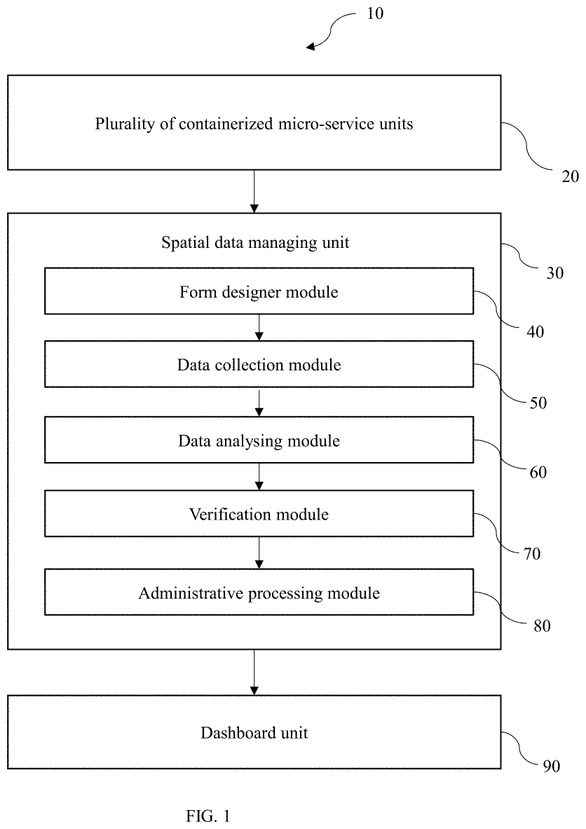

FIG. 1 is a block diagram representation of a system 10 for revenue and asset management based on micro-service architecture in accordance with an embodiment of the present disclosure. In one embodiment, the spatial intelligence solutions are being used for urban revenue and asset management. In such embodiment, revenue and asset management relates to management of municipal assets and corresponding business revenues. Corresponding business includes property tax assessment and collection, water supply asset management, sanitation, solid waste management and the like.

As used herein, the term “spatial intelligence solutions” refers to a business intelligence solution that provides location analytics to identify the relationship between certain objects based on their physical locations. As used herein, the term “micro-service architecture” refers to a software development technique, i.e. a variant of the service-oriented architecture structural style that arranges an application as a collection of loosely coupled services.

The system 10 includes one or more processors. The system 10 a plurality of containerized micro-service units 20 operable by one or more processors. The plurality of containerized micro-service units 20 is configured to manage spatial data information and a plurality of workflows in conjunction with a spatial data managing unit 30. In one embodiment, the plurality of workflows comprises data ingestion, data conversion, data visualization, role-based data access, field data collection and data management. In such embodiment, the containerized micro-service units enable a multi-tenanted access to all the services. For example, the system 10 enables interaction between municipal workers and municipal asset holders.

Furthermore, in one specific embodiment, the plurality of workflows as discussed above uses spatial data information and textual data information as provided. The provided data may be ingested, converted or managed for revenue and asset management.

The system 10 also includes the spatial data managing unit 30 operable by the one or more processors. The spatial data managing unit 30 is operatively coupled to each of the plurality of containerized micro-service units 20. In such embodiment, the spatial data managing unit 30 provides a categorized interaction mechanism for revenue and asset management. The spatial data managing unit 30 is configured to integrate the plurality of workflows in one of a form generation, data collection, data analysing, data verification and data processing.

The spatial data managing unit 10 includes a form designer module 40. The form designer module 40 is configured to design templates of a plurality of forms comprising one or more entry points for capturing data associated with revenue and asset management. In one embodiment, each of the plurality of the forms being configured to receive one or more entries corresponding to the one or more entry points by a first set of users. In another embodiment, the one or more entities comprises data in the form of spatial data information and textual data information. In yet another embodiment, the plurality of forms being designed based on jurisdictional requirements and legal requirements.

In another embodiment, the first set of users comprises individuals who own assets that is being under assessment. The assessment may be also associated to assets revenue collection by urban revenue collection bodies. As used herein, the term “form” is a document with spaces which facilitates to write or select a series of documents with similar contents.

In such embodiment, the spatial data information comprises real time data as captured by a plurality of image capturing devices corresponding to the property which is being assessed. The plurality of image capturing device may include any camera device or unmanned aerial vehicle with attached image capturing device. In such embodiment, the textual data information includes physically filled data as provided by the first set of users.

In one exemplary embodiment, the designing of each of the plurality of forms according to jurisdictional requirements refers to designing templates of each of the plurality of forms in accordance to required specific jurisdictional. Jurisdictional designing is essential as every state of a country has specific revenue and assent management techniques. In similar way, the designing of each of the plurality of forms according to legal requirements refers to designing templates of each of the plurality of forms in accordance to required specific laws. Laws may also be different in different states of a country.

The form designer module 40 is also configured to customize the plurality of forms by enabling option to at least one of addition one or more entry points, deletion of one or more entry points, and duplication of one or more entry points or combination thereof.

In one embodiment, the plurality of forms is customised in category and sub-category wise formats for collecting each of the one or more entities categorically. In one particular embodiment, such categorization and sub-categorization enables each of the first set of users to establish parent child relationship as prevalent in corresponding assets. For example, an asset such as water pipe running through a particular area may have many attached valves. Each of the water tank attached valves will have few characteristics same to the main water tank input valve. In such example, the main water tank valve behaves as parent and the attached valve behaves as children.

In yet another embodiment, the plurality of forms is designed to incorporate details about the property within a particular geofenced area. For example, each of the plurality of forms may incorporate all asset details related to a geofenced asset area. All asset property details present within the geofenced detect area may be incorporated easily via the customized forms.

For customization and data capturing, the form design module 40 uses many widgets such as text feature widget, image feature widget, signature widget, Boolean feature widget and the like. In such embodiment, widgets are interlinked, to enable skip logic and to create relationships between individual forms. The form designer module 40 also allows users to structure data collection in projects, enable notifications and create parent-child relationships between forms for an on-the-fly user generated database structure.

The spatial data managing unit 30 also includes a data collection module 50. The data collection module 30 is configured to collect the one or more entries from the plurality of forms via a plurality of feature detection techniques. In one embodiment, the textual data information may be provided in text format by the first set of users. In such embodiment, the plurality of forms is customized for written text information.

In another embodiment, the spatial data information includes images or videos as captured by different image capturing devices. In such embodiment, the data collection module 40 enable drag and drop feature for providing data. In one specific embodiment, a handheld device with a user-defined data template collects data in a structured manner.

In such embodiment, the plurality of feature detection techniques comprises of neural network technique and object detection technique. In such embodiment, the details corresponding to the property comprises usage details of the property which is being assessed or area details of the property which is being assessed. In one exemplary embodiment, the image capturing device captures images of any signboard, and via a neural network technique the signboard is deciphered. In such exemplary embodiment, such data is being captured as spatial data information. The detection technique also enables detection of electric poles, trees, municipal street furniture, sewerage manholes, fire hydrants, water supply appurtenances and the like automatically by leveraging pre-trained machine learning models available as a separate microservice with the system 10.

Furthermore, for revenue administration, the data collection module 40 allows users to collect attribute-based data, digital photographs of buildings and premises as well as the data collection module 40 allows drawing of the geographic extents of the buildings, floors, premises and constructed units on the handheld device. In addition, advanced geometric operations like digitizing or vectorizing new building footprints, splitting and merging building footprints, updating geometry and the like are enabled for administrative workers to update data with geometric integrity from the field. The data collected by the data collection module 40 is seamlessly synchronized with the core platform, which enables a top-down view of the administrative boundary, buildings, indoor floor-wise maps of all buildings and individual premises.

Simultaneously, for asset administration, the data collection module 40 allows the administrative workers to collect attribute-based data, media files (photographs, audio, video content) and feature geometry using advanced Geographic Information System (GIS) data collection tools in both online and offline modes.

The spatial data managing unit 30 also includes a data analysing module 60. The data analysing module 60 is configured to analysis each of collected one or more entries via an analysing technique. In one embodiment, the analysing technique comprises comparing each of the one or more entries with details corresponding to the property which is being assessed.

In one exemplary embodiment, a textual data information of a property as provided by each of the first set of users is cross checked by comparing corresponding spatial data information of the property. The textual data information is analysed by natural language processing, and then compared with the image captured data of the property. For comparing, the data analysing module 60 uses machine learning technique, artificial neural network and the like for comparing.

As used herein, the term “Natural language processing” is a subfield of linguistics, computer science, information engineering, and artificial intelligence concerned with the interactions between computers and human languages, in particular how to program computers to process and analyse large amounts of natural language data. As used herein, “machine learning” refers to an application of artificial intelligence (AI) that provides systems the ability to automatically learn and improve from experience without being explicitly programmed.

The spatial data managing unit 30 also includes a verification module 70. The verification module 70 is configured to receive verification from a second set of users about each of the collected one or more entries to generate one or more verified entries. In one embodiment, verification may be manual checking. In another embodiment, the second set of users may be administrative workers for property asset and revenue management. In one specific embodiment, upon detection of unverified data in the collected one or more entries a reverification notification is generated and sent to the first set of users. The reverification notification may be provided to the first set of users or to the second set of users. The spatial data managing unit 30 also uses various reporting tools for report generation.

The spatial data managing unit 30 also includes an administrative processing module 80. The administrative processing module 80 is configured to enable administrative management of different domains of the revenue and asset management corresponding to each of the one or more verified entries. In one embodiment, as stated different domain comprises property tax collection, water tax collection and the like. Such administrative management may be used by the administrative workers for property asset and revenue management.

The system 10 also includes a dashboard unit 90 operable by the one or more processors. The dashboard unit 90 is operatively coupled to spatial data managing unit 30. The dashboard unit 90 is configured to display at least one of the collected one or more entries after analysis, the one or more verified entries, and ongoing administrative management of different domains of the revenue and asset management with respect to the property being assessed over a geographical information system map. The dashboard unit 90 can also be pre-configured by the processor. As used herein, the term “Geographic Information System” is a system designed to capture, store, manipulate, analyse, manage, and present spatial or geographic data. As used herein, the term “dashboard” is a type of graphical user interface which often provides at-a-glance views of key performance indicators relevant to a particular objective or business process.

In one embodiment, Geographic Information System base map of the urban local body (ULB) may be added in a variety of formats. It is pertinent to note that, proprietary and commercial-off-the-shelf GIS software is customized heavily for above mentioned usage. In such embodiment, the system 10 allows creation and setting up of a new urban local body (ULB) and corresponding basic information, uploading and linking city limits, ward boundaries in geospatial file formats and also enable setting up of revenue and asset management workflows.

In one specific embodiment, for revenue management, the system 10 enables the ULBs in accurate assessment of tax demand from the buildings located in corresponding jurisdiction. Using the base maps uploaded by the user for the ULB, any administrator worker may designate building footprints to be used in the field for identifying properties. The footprints are transmitted to the mobile devices using spatial extents and any other attributes available with the base maps.

In another specific embodiment, for asset management, the system 10 allows users to map the municipal assets, update the status or health in specific field and use the data for effectively managing the assets. The multi-tenancy architecture to build various modules pertaining to different municipal functions, for example: managing water supply, sanitation, roads, streetlights, fire hydrants, municipal real estate, markets and shops, street fixtures, etc. Base map data, which is served to the web map interface as well as the mobile interface, is available for asset mapping and updating.

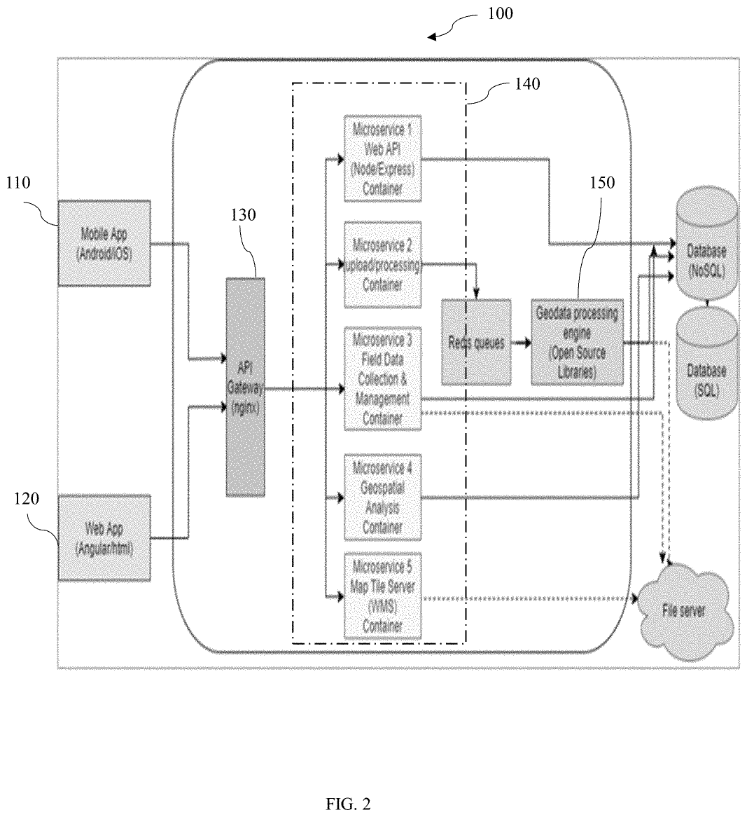

FIG. 2 is a schematic representation of an embodiment representing the micro-service architecture 100 used for managing revenue and asset in accordance of an embodiment of the present disclosure. It is pertinent to note that, the system 10 may be accessed via webpage 120 or mobile application 110 after proper authentication or registration at application gateway 130. Furthermore, the plurality of workflows is managed via a number of microservice containers 140. As used herein, the term “containers” are packages of your software that includes everything that it needs to run, like code, dependencies, libraries, binaries, and more.

Simultaneously, the plurality of workflows uses geodata processing 150 for performing operations related to the revenue and asset management system. All processed information may be stored locally or remotely in a database storage module. A domain specific language, such as Structured Query Language (SQL) and Not Only Structured Query Language (NoSQL) may be used managing the database as stored.

In one specific embodiment, the system 100 includes a messaging broker configured to perform key tasks of clearly dividing the microservices and the consumers of the platform, along with storing, routing, checking and organizing messages or data streams ingested on spatial engine. In such embodiment, the messaging broker also enables multiple users in the field to stream corresponding data and media files. In case, the urban local body intends to install and use IoT devices for various city operations, the messaging broker enables making the process of data exchange simple and reliable.

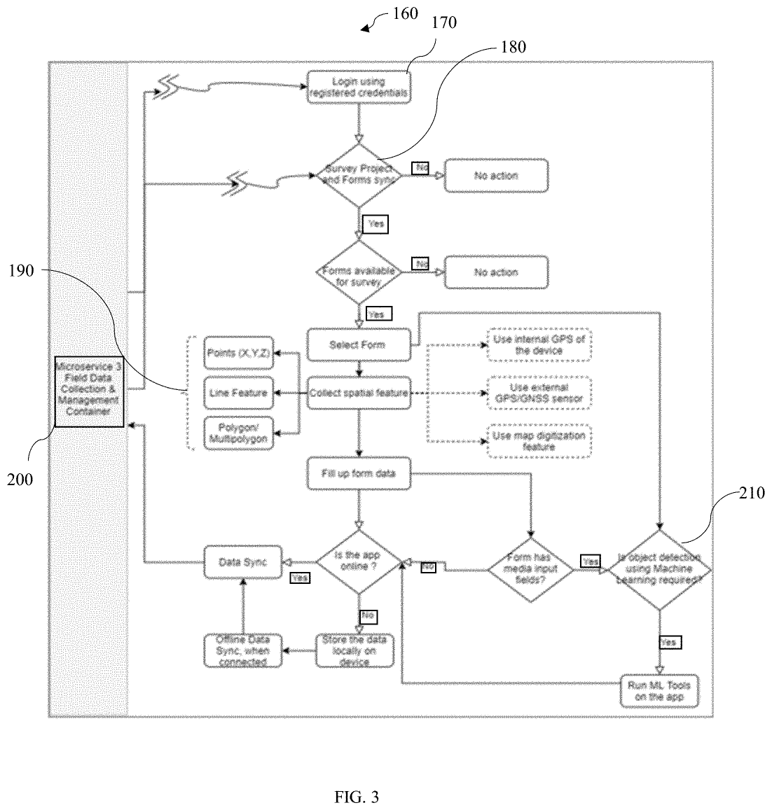

FIG. 3 is a schematic representation of an embodiment representing process of management of spatial data information 160 as stated in FIG. 1 in accordance of an embodiment of the present disclosure. Any user at first step registers in the system 10 via registration credentials 170. For any particular survey, all forms are designed and customized through a form designer module 180. The user may select any form and provide textual data information and spatial data information.

The spatial data information 190 includes point system (x, y, z) spatial data, line feature spatial data and polygon spatial data and multi-polygon spatial data. Such data may easily be incorporated via Global positioning system. In one embodiment, map digitization technique may be used to provide spatial data information. All such collection spatial information data is undertaken by field data collection and management container 200.

After user fills such specific designed forms, all data are synced with the system 10 and stored in a storage database. In one embodiment, the storage database may be a remote storage or local storage. In another embodiment, all spatial information data are analysed by different detection techniques 210 such as object detection technique and the like. Further, the collected data may be examined for further processing and run through various machine learning tools.

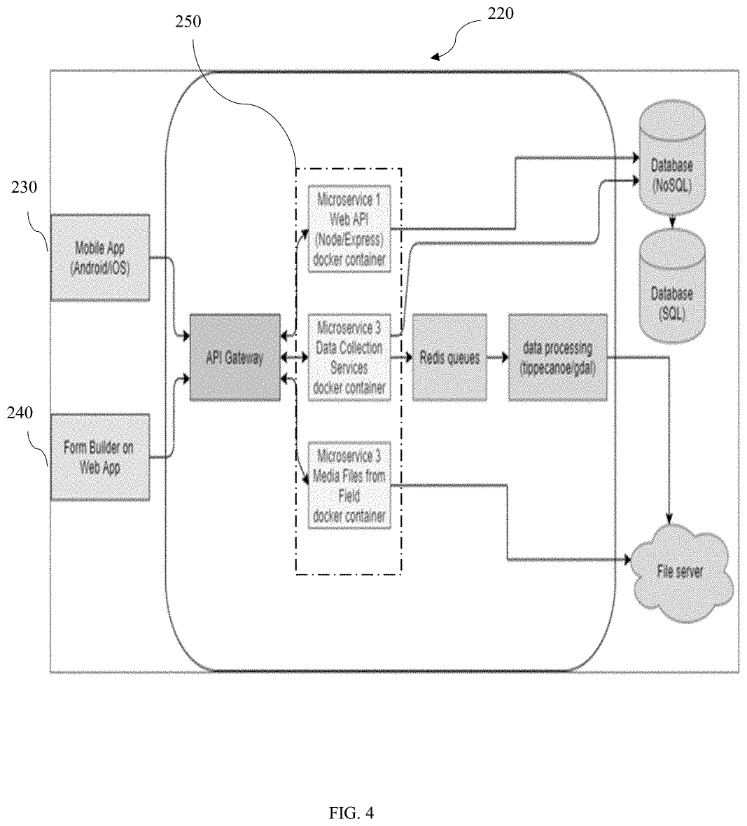

FIG. 4 is a schematic representation of an embodiment representing the plurality of workflows 220 used for managing revenue and asset of FIG. 1 in accordance of an embodiment of the present disclosure. The disclosed schematic representation 220 provides the flow of customizing and designing form 240 in system 10 customized mobile application 230. The process of managing the assets and revenue takes place via various microservice containers 250.

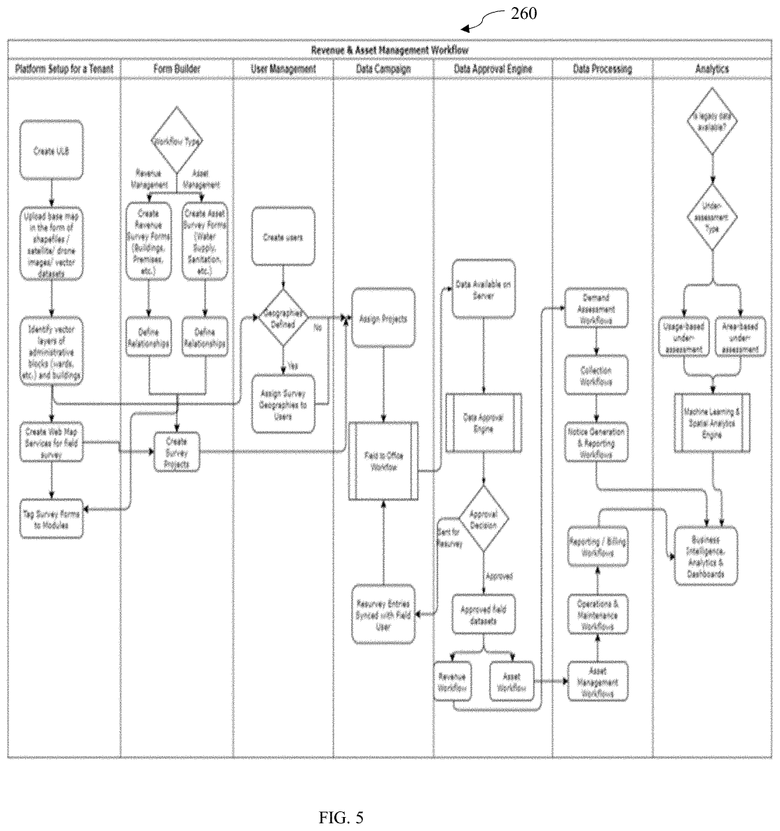

FIG. 5 is a schematic representation of an embodiment representing the total workflow of revenue and asset management 260 of FIG. 1 in accordance of an embodiment of the present disclosure. The whole workflow first involves surveying and uploading in the system 10 surveyed images or spatial data. Here, basically identification of assets or buildings are done as they are surveyed and stored in database.

Further, via the system 10, a form may be designed and filled up by a tenant. The tenant may specify the type of assessment such as revenue evaluation or asset evaluation. In one embodiment, the revenue evaluation involves evaluation of buildings, premises and the like. In another embodiment, the asset evaluation involves water supply, sanitation and the like.

It is pertinent to not that, all such filled digital forms may be manually verified or cross-checked before administrative processing work. All provided verified data is incorporated in the system 10 for administrative processing work. The system 10 analyses the survey verified property for administrative work via two process mainly, i.e. under usage-based assessment or under area-based assessment. Such assessment allows easy handling of administrative work. Some administrative work may be operation and management of assets, billing of revenue and the like.

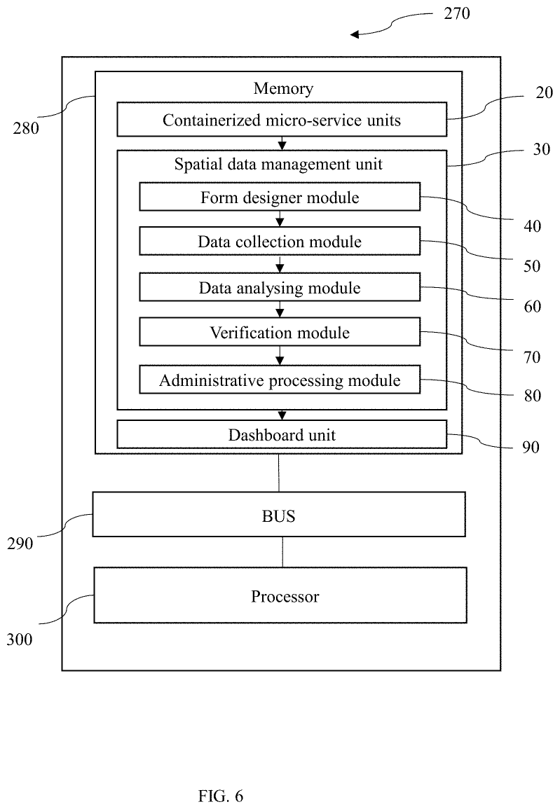

FIG. 6 is a block diagram of a computer or a server 270 in accordance with an embodiment of the present disclosure. The server 270 includes processors 300, and memory 280 coupled to the processors 300.

The processor(s) 300, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 280 includes a plurality of modules stored in the form of executable program which instructs the processor 300 via a bus 290 to perform the method steps illustrated in FIG. 1. The memory 280 has following units: the plurality of containerized micro-service units 20, the spatial data managing unit 30 and dashboard unit 90. The spatial data managing unit 30 includes following modules: the form designer module 40, the data collection module 50, the data analysing module 60, the verification module 70 and the administrative processing module 80.

The plurality of containerized micro-service units 20 is configured to manage spatial data information and a plurality of workflows in conjunction with a spatial data managing unit. The spatial data managing unit 30 is configured to integrate the plurality of workflows in one of a form generation, data collection, data analysing, data verification and data processing. The dashboard unit 90 is configured to display at least one of the collected one or more entries after analysis, the one or more verified entries, and ongoing administrative management of different domains of the revenue and asset management with respect to the property being assessed over a geographical information system map.

The form designer module 40 is configured to design templates of a plurality of forms comprising one or more entry points for capturing data associated with revenue and asset management. The form designer module 40 is also configured to customize the plurality of forms by enabling option to at least one of addition one or more entry points, deletion of one or more entry points, and duplication of one or more entry points or combination thereof. The data collection module 50 is configured to collect the one or more entries from the plurality of forms via a plurality of feature detection techniques.

The data analysing module 60 configured to analyse each of collected one or more entries via an analysing technique. The verification module 70 configured to receive verification from a second set of users about each of the collected one or more entries to generate one or more verified entries. The administrative processing module 80 configured to enable administrative management of different domains of the revenue and asset management corresponding to each of the one or more verified entries.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 300.

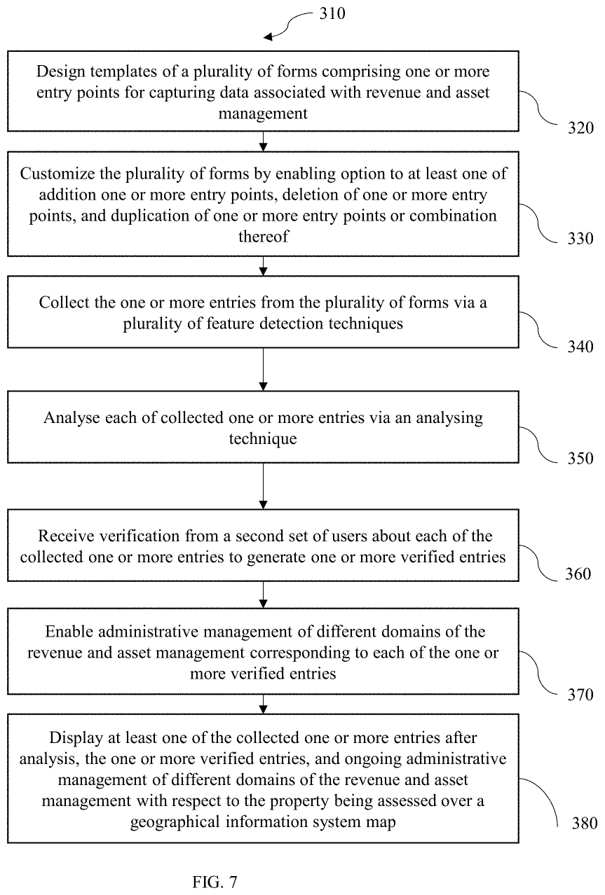

FIG. 7 is a flowchart representing the steps of a method 310 for managing revenue and asset by a micro-service architecture in accordance with an embodiment of the present disclosure. The method 310 includes designing templates of a plurality of forms comprising one or more entry points for capturing data associated with revenue and asset management in step 320. In one embodiment, designing templates of the plurality of forms comprising the one or more entry points for capturing data associated with revenue and asset management includes designing templates of the plurality of forms comprising the one or more entry points for capturing data associated with revenue and asset management by a form design module.

In another embodiment, designing templates of the plurality of forms comprising the one or more entry points for capturing data associated with revenue and asset management includes receiving one or more entries corresponding to the one or more entry points by a first set of users. In yet another embodiment, designing templates of the plurality of forms comprising the one or more entry points for capturing data associated with revenue and asset management includes designing, by the form design module, templates of the plurality of forms for the first set of users to provide one or more entries comprising spatial data information and textual data information. In one embodiment, designing templates of the plurality of forms comprising the one or more entry points for capturing data associated with revenue and asset management includes designing the plurality of forms based on jurisdictional requirements and legal requirements.

The method 310 also includes customizing the plurality of forms by enabling option to at least one of addition one or more entry points, deletion of one or more entry points, and duplication of one or more entry points or combination thereof in step 330. In one embodiment, customizing the plurality of forms by enabling option to at least one of addition the one or more entry points, deletion of the one or more entry points, and duplication of the one or more entry points or combination thereof includes customizing the plurality of forms by the form design module.

In yet another embodiment, customizing the plurality of forms by enabling option to at least one of addition the one or more entry points, deletion of the one or more entry points, and duplication of the one or more entry points or combination thereof includes customizing the plurality of forms in category and sub-category wise formats for gathering each of the one or more entities categorically. In one embodiment, customizing the plurality of forms by enabling option to at least one of addition the one or more entry points, deletion of the one or more entry points, and duplication of the one or more entry points or combination thereof includes customizing the plurality of forms to incorporate details corresponding to the property which is being assessed within a particular geofenced area. Integration with geofencing ensures that the first user (such as field surveyor) has to be physically present in the premises of the property while inputting data in the one or more entries of the form. Thereby, this prevents upload of wrong data for assessment.

The method 310 also includes collecting one or more entries from the plurality of forms via a plurality of feature detection techniques in step 340. In one embodiment, collecting the one or more entries from the plurality of forms via the plurality of feature detection techniques includes collecting the one or more entries from the plurality of forms via the plurality of feature detection techniques by a data collection module.

In another embodiment, collecting the one or more entries from the plurality of forms via the plurality of feature detection techniques includes collecting one or more entries from the plurality of forms via the plurality of feature detection techniques comprising of neural network technique and object detection technique. In yet another embodiment, collecting the provided spatial data information via the plurality of feature detection techniques includes collecting the spatial data information comprising real time data as captured by a plurality of image capturing devices corresponding to the property which is being assessed.

The method 310 also includes analysing each of collected one or more entries via an analysing technique in step 350. In one embodiment, analysing each of the collected one or more entries via the analysing technique includes analysing each of the collected one or more entries via the analysing technique by the data analysing module. In another embodiment, analysing each of the collected one or more entries via the analysing technique includes analysing each of the collected one or more entries by comparing each of the one or more entries with details corresponding to the property which is being assessed.

In yet another embodiment, analysing each of the collected one or more entries via the analysing technique includes wherein analysing the details corresponding to the property comprising usage details of the property which is being assessed or area details of the property which is being assessed.

The method 310 also includes receiving verification from a second set of users about each of the collected one or more entries to generate one or more verified entries in step 360. In one embodiment, receiving verification from the second set of users about each of the collected one or more entries to generate one or more verified entries includes receiving verification from the second set of users about each of the collected one or more entries to generate one or more verified entries by a verification module. In another embodiment, receiving verification from the second set of users about each of the collected one or more entries to generate one or more verified entries includes generating a reverification notification upon detection of unverified data in the collected one or more entries. In yet another embodiment, receiving verification from the second set of users about each of the collected one or more entries to generate one or more verified entries includes sending the reverification notification to the first set of users.

The method 310 also includes enabling administrative management of different domains of the revenue and asset management corresponding to each of the one or more verified entries in step 370. In one embodiment, enabling administrative management of different domains of the revenue and asset management corresponding to each of the one or more verified entries includes enabling administrative management of different domains of the revenue and asset management corresponding to each of the one or more verified entries by an administrative processing module.

The method 310 also includes displaying at least one of the collected one or more entries after analysis, the one or more verified entries, and ongoing administrative management of different domains of the revenue and asset management with respect to the property being assessed over a geographical information system map in step 380. In one embodiment, displaying at least one of the collected one or more entries after analysis, the one or more verified entries, and ongoing administrative management of different domains of the revenue and asset management with respect to the property being assessed over the geographical information system map includes displaying at least one of the collected one or more entries after analysis, the one or more verified entries, and ongoing administrative management of different domains of the revenue and asset management with respect to the property being assessed over the geographical information system map by a dashboard unit.

The method 310 also includes managing a spatial data information and a plurality of workflows in conjunction with a spatial data managing unit. In one embodiment, managing the spatial data information and the plurality of workflows in conjunction with the spatial data managing unit includes managing the spatial data information and the plurality of workflows in conjunction with the spatial data managing unit by the plurality of containerized micro-service units. In another embodiment, managing the spatial data information and the plurality of workflows in conjunction with the spatial data managing unit includes the plurality of workflows comprising data ingestion, data conversion, data visualization, role-based data access, field data collection and data management.

Present disclosure of a system for revenue and asset management on micro-service architecture enables the capability of microservices architecture to achieve scalability and easy deployment across server systems. The urban processes are pre-installed and available as separate microservices, which may be configured by a new city or urban local body to start using immediately. The system maps buildings, individual floors and the units or premises on the floors, thereby generating the most comprehensive hyperlocal database of the urban local body. The basic premise of form design module is to bring in flexibility in designing any forms and assigning them to the users to effectively collect relevant field data for revenue and/or asset management. Vernacular forms may also be easily designed.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A system for revenue and asset management based on micro-service architecture, comprising:
one or more processors;
a plurality of containerized micro-service units operable by one or more processors, wherein the plurality of containerized micro-service units is configured to manage spatial data information and a plurality of workflows in conjunction with a spatial data managing unit,
wherein the plurality of workflows comprises data ingestion, data conversion, data visualization, role-based data access, field data collection and data management;
the spatial data managing unit operable by the one or more processors and operatively coupled to each of the plurality of containerized micro-service units, wherein the spatial data managing unit is configured to integrate the plurality of workflows in one of a form generation, data collection, data analysing, data verification and data processing, wherein the spatial data managing unit comprises:
a form designer module configured to:
design templates of a plurality of forms comprising one or more entry points for capturing data associated with revenue and asset management, wherein the plurality of forms being designed based on jurisdictional requirements and legal requirements, wherein each of the plurality of the forms being configured to receive one or more entries corresponding to the one or more entry points by a first set of users, wherein the one or more entries comprises spatial data information and textual data information; and
customize the plurality of forms by enabling option to at least one of addition one or more entry points, deletion of one or more entry points, and duplication of one or more entry points or combination thereof;
a data collection module configured to collect the one or more entries from the plurality of forms via a plurality of feature detection techniques;
a data analysing module configured to analyse each of the collected one or more entries via an analysing technique, wherein the analysing technique comprises comparing each of the one or more entries with details corresponding to the property which is being assessed;
a verification module configured to receive verification from a second set of users about each of the collected one or more entries to generate one or more verified entries, wherein upon detection of unverified data in the collected one or more entries a reverification notification is generated and sent to the first set of users;
an administrative processing module configured to enable administrative management of different domains of the revenue and asset management corresponding to each of the one or more verified entries; and
a dashboard unit operable by the one or more processors, and operatively coupled to special data managing unit, wherein the dashboard unit is configured to display at least one of the collected one or more entries after analysis, the one or more verified entries, and ongoing administrative management of different domains of the revenue and asset management with respect to the property being assessed over a geographical information system map.

2. The system as claimed in claim 1, wherein the spatial data information comprises real time data as captured by a plurality of image capturing devices corresponding to the property which is being assessed.

3. The system as claimed in claim 1, wherein the plurality of forms is customised in category and sub-category wise formats for gathering each of the one or more entities categorically.

4. The system as claimed in claim 1, wherein the plurality of forms is designed to include details corresponding to the property which is being assessed within a geofenced area.

5. The system as claimed in claim 1, wherein the plurality of feature detection techniques comprises of neural network technique and object detection technique.

6. The system as claimed in claim 1, wherein the details corresponding to the property comprises usage details of the property which is being assessed or area details of the property which is being assessed.

7. A method for managing revenue and asset by a micro-service architecture, comprising:
designing, by a form design module, templates of a plurality of forms comprising one or more entry points for capturing data associated with revenue and asset management;
customizing, by the form design module, the plurality of forms by enabling option to at least one of addition the one or more entry points, deletion of the one or more entry points, and duplication of the one or more entry points or combination thereof;
collecting, by a data collection module, the one or more entries from the plurality of forms via a plurality of feature detection techniques;
analysing, by the data analysing module, each of collected one or more entries via an analysing technique;
receiving, by a verification module, verification from a second set of users about each of the collected one or more entries to generate one or more verified entries;
enabling, by an administrative processing module, administrative management of different domains of the revenue and asset management corresponding to each of the one or more verified entries; and
displaying, by a dashboard unit, at least one of the collected one or more entries after analysis, the one or more verified entries, and ongoing administrative management of different domains of the revenue and asset management with respect to the property being assessed over a geographical information system map.

8. The method as claimed in claim 7, comprising managing, by a plurality of containerized micro-service units, a spatial data information and a plurality of workflows in conjunction with a spatial data managing unit.

9. The method as claimed in claim 8, wherein managing, by the plurality of containerized micro-service units, the plurality of workflows comprising data ingestion, data conversion, data visualization, role-based data access, field data collection and data management.

10. The method as claimed in claim 7, wherein receiving, by the form design module, one or more entries corresponding to the one or more entry points by a first set of users.

11. The method as claimed in claim 7, wherein designing, by the form design module, templates of the plurality of forms for the first set of users to provide one or more entries comprising spatial data information and textual data information.

12. The method as claimed in claim 7, wherein designing, by the form design module, the plurality of forms based on jurisdictional requirements and legal requirements.

13. The method as claimed in claim 7, wherein collecting, by the data collection module, each of the collected one or more entries via the plurality of feature detection techniques comprising of neural network technique and object detection technique.

14. The method as claimed in claim 7, wherein analysing, by the data analysing module, each of the collected one or more entries by comparing each of the one or more entries with details corresponding to the property which is being assessed.

15. The method as claimed in claim 7, wherein generating, by the verification module, a reverification notification upon detection of unverified data in the collected one or more entries.

16. The method as claimed in claim 15, wherein sending, by the verification module, the reverification notification to the first set of users.

17. The method as claimed in claim 7, wherein collecting, by the data collection module, the spatial data information comprising real time data as captured by a plurality of image capturing devices corresponding to the property which is being assessed.

18. The method as claimed in claim 7, wherein customizing, by the form design module, the plurality of forms in category and sub-category wise formats for gathering each of the one or more entities categorically.

19. The method as claimed in claim 7, wherein customizing, by the form design module, the plurality of forms to incorporate details corresponding to the property which is being assessed within a particular geofenced area.

20. The method as claimed in claim 7, wherein analysing, by the data analysing module, the details corresponding to the property comprising usage details of the property which is being assessed or area details of the property which is being assessed.
